(19) United States
(12) Patent Application Publication
(10) Pub. No.: US 2023/0094772 A1
(43) Pub. Date: Mar. 30, 2023

(54) SECONDARY BATTERY ELECTROLYTE AND LITHIUM SECONDARY BATTERY INCLUDING THE SAME

(71) Applicant: SK ON CO., LTD., Seoul (KR)

(72) Inventors: Jin Hong LEE, Daejeon (KR); Chan Woo KIM, Daejeon (KR); Sung Jin KIM, Daejeon (KR); In Haeng CHO, Daejeon (KR)

(21) Appl. No.: 17/955,213

(22) Filed: Sep. 28, 2022

(30) Foreign Application Priority Data
Sep. 28, 2021 (KR) 10-2021-0128105

(51) Int. Cl. H01M 10/0567; H01M 10/0568; H01M 10/42; H01M 10/052; C07F 9/6574

(52) U.S. Cl. CPC H01M 10/0567; H01M 10/0568; H01M 10/4235; H01M 10/052; C07F 9/65742; H01M 2300/0025

(57) ABSTRACT

The disclosed technology relates to a secondary battery electrolyte and a lithium secondary battery including the same. The secondary battery electrolyte of the disclosed technology includes a cyclophosphate compound as an additive, such that the secondary battery electrolyte has excellent flame retardancy while improving charge and discharge efficiency, lifespan characteristics, high-temperature characteristics, and high-temperature storage stability of a lithium secondary battery including the same.

### CROSS-REFERENCE TO RELATED APPLICATIONS

This application claims priority under 35 U.S.C. §119 to Korean Patent Application No. 10-2021-0128105, filed on Sep. 28, 2021, in the Korean Intellectual Property Office, the disclosure of which is incorporated herein by reference in its entirety.

### TECHNICAL FIELD

The following disclosure relates to a secondary battery electrolyte and a lithium secondary battery including the same, and more particularly, to a secondary battery electrolyte having improved flame retardancy and a lithium secondary battery including the same.

### BACKGROUND

Recently, as an industrial environment is changed to pursue energy, studies on a new energy source have been intensively conducted.

As such an energy source, a lithium secondary battery already has been efficiently used as a power supply for mobile devices such as a smart phone and a laptop computer or electric vehicles because it has a high energy density and low self-discharge.

Recently, a lithium secondary battery has been used as a main power source or an auxiliary power source of an electric vehicle or a hybrid vehicle.

Therefore, there is a need for a lithium secondary battery having a high energy density to exhibit high performance and stably supply power.

However, when an operating voltage range is widened while using an additive for an electrolyte according to the related art for a high voltage lithium secondary battery as it is, internal resistance and a lifespan of the battery are rapidly reduced.

That is, when a general electrolyte according to the related art is used, battery characteristics are excellent at a voltage of 4.2 V or lower; however, as the voltage is increased, a battery performance is deteriorated at a voltage of 4.2 V or higher.

In addition, since a non-aqueous electrolyte used as a general electrolyte is flammable, an internal pressure of an element is increased due to damage caused by an external impact, heat, an over-voltage, and the like, and thus, the electrolyte may be leaked. The leaked electrolyte easily ignites, resulting in damage to a device or occurrence of a fire.

In particular, as a capacitor used for a vehicle is enlarged and mounted in a large number, a risk of fire is increased. Therefore, there is a need for an electrolyte having flame retardancy.

### SUMMARY

The technology disclosed in this patent document is developed in part based on the recognition that an electrolyte, once modified in its composition to improve its flame retardancy, certain electrolyte characteristics such as the electrical conductivity, the lifespan characteristics, and the charge and discharge efficiency may be undesirably deteriorated. Thus, to achieve desired flame retardancy, the technology disclosed in this patent document can be used to provide electrolytes having flame retardancy while maintaining other electrolyte characteristics at their desired levels.

An embodiment of the disclosed technology is directed to providing a secondary battery electrolyte having improved flame retardant characteristics while maintaining high-efficiency charge and discharge characteristics, high-temperature characteristics, and lifespan characteristics, and a lithium secondary battery including the same.

In one general aspect, a secondary battery electrolyte includes:

a lithium salt;

a non-aqueous organic solvent; and

a cyclophosphate compound represented by the following Chemical Formula 1:

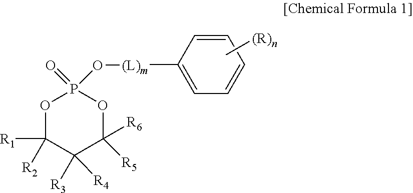

in Chemical Formula 1,

R₁ to R₆ are each independently hydrogen, C1-C10 alkyl, or C6-C12 aryl C1-C10 alkyl;

L is C1-C5 alkylene;

R is fluoro or fluoro C1-C10 alkyl;

m is an integer of 0 to 2; and

n is an integer of 0 to 5.

In Chemical Formula 1, R₁ to R₆ may be each independently hydrogen, C1-C5 alkyl, or C1-C5 alkyl substituted with phenyl; L may be C1-C3 alkylene; R may be fluoro or fluoro C1-C5 alkyl; m may be an integer of 0 or 1; and n may be an integer of 0 to 2.

The cyclophosphate compound may be represented by the following Chemical Formula 2:

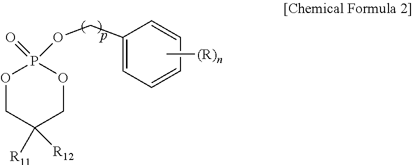

in Chemical Formula 2,

R is fluoro or fluoro C1-C10 alkyl;

R₁₁ and R₁₂ are each independently hydrogen, C1-C10 alkyl, or C6-C12 aryl C1-C10 alkyl;

p is an integer of 0 to 3; and

n is an integer of 0 to 5.

In Chemical Formula 2, R may be fluoro or perfluoro C1-C5 alkyl; R₁₁ and R₁₂ may be each independently hydrogen, C1-C5 alkyl, or phenyl C1-C5 alkyl; p may be an integer of 0 to 2; and n may be an integer of 0 to 3.

The cyclophosphate compound may be selected from, but is not limited to, the following compounds:

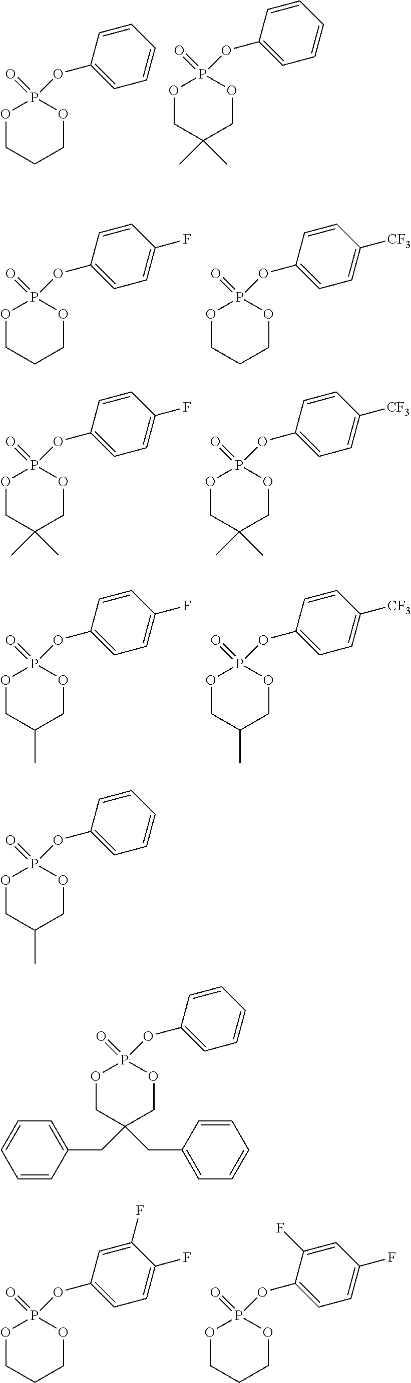

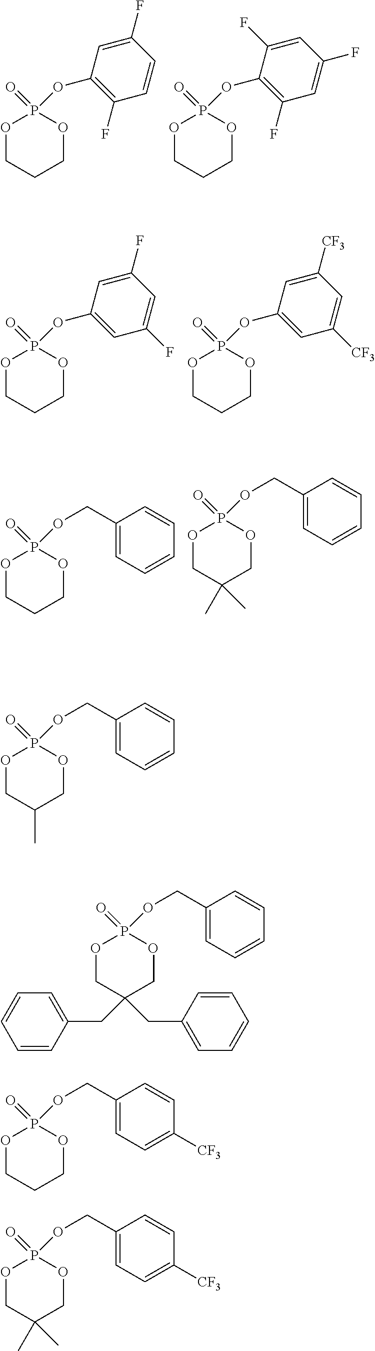

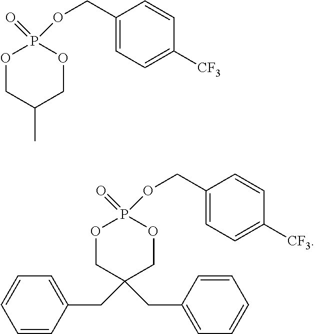 [SMILES: CC1COP(=O)(OCc2ccc(C(F)(F)F)cc2)OC1 ; O=P1(OCc2ccc(C(F)(F)F)cc2)OCC(Cc2ccccc2)(Cc2ccccc2)CO1]

The cyclophosphate compound may be in an amount of 1 to 15 wt % with respect to a total weight of the secondary battery electrolyte.

The secondary battery electrolyte may further include one or two or more additives selected from an oxalatoborate-based compound, an oxalatophosphate-based compound, a fluorine-substituted carbonate-based compound, a vinylidene carbonate-based compound, or a sulfinyl group-containing compound. In some implementations, the one or two or more additives may be selected from the group consisting of an oxalatoborate-based compound, an oxalatophosphate-based compound, a fluorine-substituted carbonate-based compound, a vinylidene carbonate-based compound, and a sulfinyl group-containing compound. The additive may be in an amount of 0.2 to 5 wt % with respect to a total weight of the secondary battery electrolyte.

In some implementations, the lithium salt may include one or two or more selected from LiPF₆, LiBF₄, LiClO₄, LiSbF₆, LiAsF₆, LiN(SO₃C₂F₅)₂, LiCF₃SO₃, LiC₄F₉SO₃, LiC₆H₅SO₃, LiSCN, LiAlO₂, LiAlCl₄, LiCl, LiI, or LiB(C₂O₄)₂. The lithium salt may be present in an amount of 0.3 to 1.2 moles in some implementations.

In another general aspect, a lithium secondary battery includes: a cathode; an anode; a separator interposed between the cathode and the anode; and the secondary battery electrolyte.

Other features and aspects will be apparent from the following detailed description, the drawings, and the claims.

### DETAILED DESCRIPTION OF EMBODIMENTS

Hereinafter, examples of implementations of the disclosed technology are described in more detail.

The term “alkyl” in the disclosed examples refers to an aliphatic hydrocarbon group having 1 to 10 carbon atoms, preferably 1 to 8 carbon atoms, more preferably 1 to 5 carbon atoms, and still more preferably 1 to 4 carbon atoms. The alkyl used alone or in combination may be linear or branched alkyl. Specific examples of the linear or branched alkyl may include methyl, ethyl, n-propyl, isopropyl, n-butyl, isobutyl, tert-butyl, n-pentyl, neopentyl, n-hexyl, isohexyl, n-heptyl, n-octyl, n-nonyl, and n-decyl.

The term “fluoroalkyl” in the disclosed examples means that some or all hydrogens present in alkyl are substituted with fluoro, and examples thereof may include —CF₃, —CH₂CF₃, and —CF₂CF₃.

The term “fluoro-substituted cyclic carbonate” in the disclosed examples means that hydrogen present in cyclic carbonate is substituted with one or more fluoro, and examples thereof may include fluoroethylene carbonate and fluoropropylene carbonate.

The term “perfluoro alkyl” in the disclosed examples means that all hydrogens are substituted with fluoro, the hydrogen being present in alkyl having 1 to 10 carbon atoms, preferably 1 to 6 carbon atoms, and more preferably 1 to 4 carbon atoms, and examples thereof may include trifluoromethane and pentafluoroethane.

The term “aryl” in the disclosed examples refers to a carbocyclic aromatic group including 5 to 10 ring atoms. Representative examples thereof include, but are not limited to, phenyl, tolyl, xylyl, naphthyl, tetrahydronaphthyl, anthracenyl, fluorenyl, indenyl, and azulenyl. The carbocyclic aromatic group may be selectively substituted.

The term “arylalkyl” in the disclosed examples means that some or all hydrogens present in alkyl are substituted with aryl. Here, aryl and alkyl are as defined above.

The term “discharge” in the disclosed examples refers to a process of deintercalating lithium ions from an anode, and the term “charge” refers to a process of intercalating lithium ions into an anode.

The disclosed technology can be implemented in certain ways that provide a secondary battery electrolyte having significantly excellent lifespan characteristics, charge and discharge characteristics, and flame retardancy. For example, in some implementations, a secondary battery electrolyte based on the disclosed technology can include:

a lithium salt;

a non-aqueous organic solvent; and

a cyclophosphate compound represented by the following Chemical Formula 1:

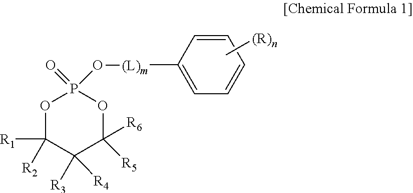

in Chemical Formula 1,

R₁ to R₆ are each independently hydrogen,C1-C10 alkyl, or C6-C12 arylC1-C10 alkyl;

L is C1-C5 alkylene;

R is fluoro or fluoro C1-C10 alkyl;

m is an integer of 0 to 2; and

n is an integer of 0 to 5.

The secondary battery electrolyte according to an exemplary embodiment of the disclosed technology includes a cyclophosphate compound represented by Chemical Formula 1, such that the secondary battery electrolyte has improved retardancy while improving charge and discharge efficiency, lifespan characteristics, and high-temperature storage stability of a lithium secondary battery including the same.

Specifically, the secondary battery electrolyte according to an exemplary embodiment of the disclosed technology includes a cyclophosphate compound, which is a specific compound, such that a lithium secondary battery including the same has further improved electrical characteristics and flame retardant characteristics.

Specifically, in Chemical Formula 1 according to an exemplary embodiment of the disclosed technology, R₁ to R₆ may be each independently hydrogen, C1-C5 alkyl, or C1-C5 alkyl substituted with phenyl; L may be C1-C3 alkylene; R may be fluoro or fluoro C1-C5 alkyl; m may be an integer of 0 or 1; and n may be an integer of 0 to 2, and more specifically, R₁ to R₆ may be each independently hydrogen, C1-C4 alkyl, or C1-C4 alkyl substituted with phenyl; L may be C1-C2 alkylene; R may be fluoro or fluoro C1-C4 alkyl; and m and n may be each independently an integer of 0 or 1.

In Chemical Formula 1 according to an exemplary embodiment of the disclosed technology, R₁ to R₆ may be each independently hydrogen or C1-C4 alkyl; L may be methylene; R may be fluoro or fluoro C1-C3 alkyl; and m and n may be each independently an integer of 0 or 1.

Specifically, the cyclophosphate compound according to an exemplary embodiment of the disclosed technology may be represented by the following Chemical Formula 2:

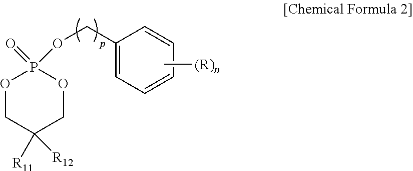

in Chemical Formula 2,

R is fluoro or C1-C10 alkyl including one or more fluoro;

Ru and R₁₂ are each independently hydrogen, C1-C10 alkyl, or C6-C 12 aryl C1-C10 alkyl;

p is an integer of 0 to 3; and

n is an integer of 0 to 5.

A lithium secondary battery including a cyclophosphate compound represented by Chemical Formula 2 according to an exemplary embodiment of the disclosed technology has further improved charge and discharge efficiency, lifespan characteristics, and high-temperature storage stability while having self-extinguishing properties.

In Chemical Formula 2 according to an exemplary embodiment of the disclosed technology, R may be fluoro or perfluoro C1-C5 alkyl; Ru and R₁₂ may be each independently hydrogen, C1-C5 alkyl, or phenyl C1-C5 alkyl; p may be an integer of 0 to 2; and n may be an integer of 0 to 3.

Specifically, in Chemical Formula 2 according to an exemplary embodiment of the disclosed technology, R may be fluoro or perfluoro C1-C4 alkyl; R₁₁ and R₁₂ may be each independently hydrogen, C1-C4 alkyl, or phenyl C1-C4 alkyl; p may be an integer of 0 to 2; and n may be an integer of 0 to 2, and as another aspect, in Chemical Formula 2, R may be fluoro or perfluoro C1-C4 alkyl; R₁₁ and R₁₂ may be each independently hydrogen or C1-C4 alkyl; p may be an integer of 0 or 1; and n may be an integer of 0 or 1.

More specifically, the cyclophosphate compound according to an exemplary embodiment of the disclosed technology may be selected from, but is not limited to, the following compounds:

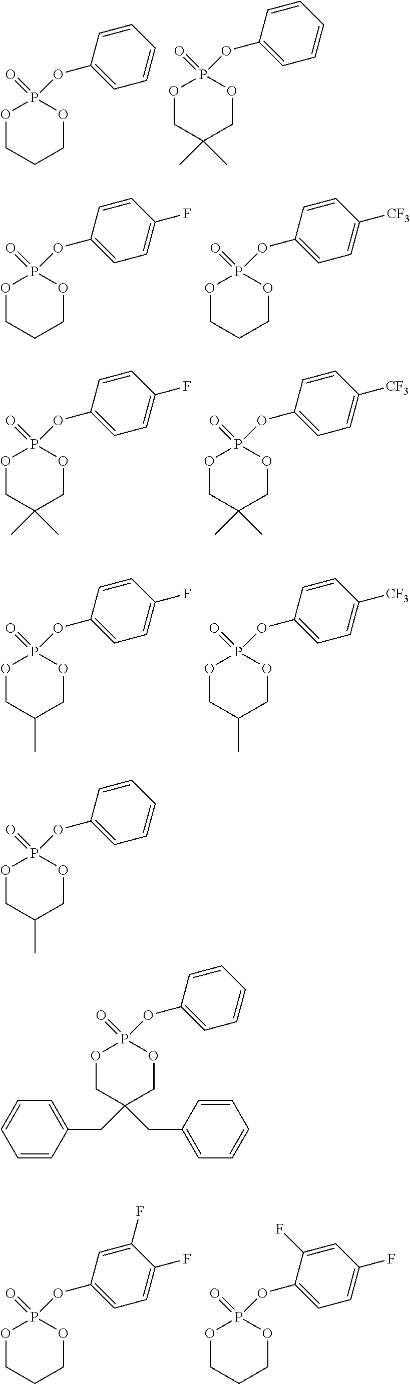

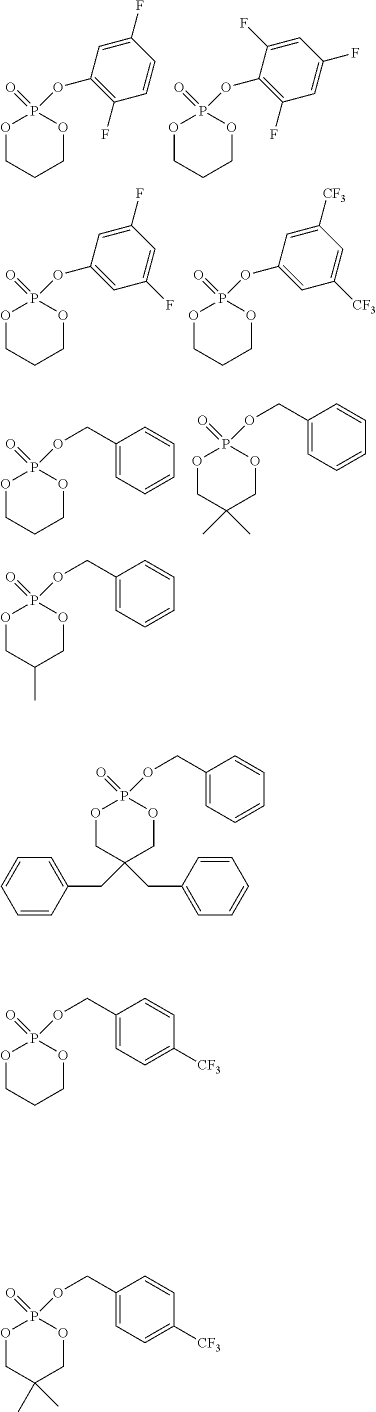

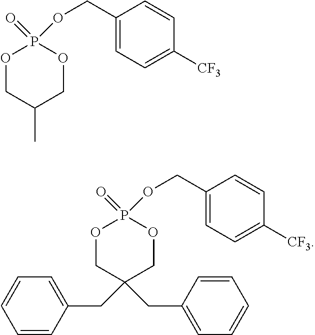 [SMILES: CC1COP(=O)(OCc2ccc(C(F)(F)F)cc2)OC1 ; O=P1(OCc2ccc(C(F)(F)F)cc2)OCC(Cc2ccccc2)(Cc2ccccc2)CO1]

The cyclophosphate compound according to an exemplary embodiment of the disclosed technology may be in an amount of 1 to 15 wt %, specifically, 3 to 15 wt %, and more specifically, 5 to 15 wt %, with respect to a total weight of the secondary battery electrolyte, and as another aspect, the cyclophosphate compound may be in an amount of 7 to 12 wt % with respect to the total weight of the secondary battery electrolyte.

Specifically, the secondary battery electrolyte according to an exemplary embodiment of the disclosed technology may further include one or two or more additives selected from an oxalatoborate-based compound, an oxalatophosphate-based compound, a fluorine-substituted carbonate-based compound, a vinylidene carbonate-based compound, or a sulfinyl group-containing compound.

The secondary battery electrolyte according to an exemplary embodiment of the disclosed technology may further include an oxalatoborate-based compound. The secondary battery electrolyte includes the cyclophosphate compound and the oxalatoborate-based compound of the disclosed technology in combination, such that flame retardancy and electrical characteristics may be further improved.

The secondary battery electrolyte according to an exemplary embodiment of the disclosed technology may further include an oxalatoborate-based compound.

The secondary battery electrolyte according to an exemplary embodiment of the disclosed technology may further include a fluorine-substituted carbonate-based compound.

The secondary battery electrolyte according to an exemplary embodiment of the disclosed technology may further include a vinylidene carbonate-based compound.

The secondary battery electrolyte according to an exemplary embodiment of the disclosed technology may further include a sulfinyl group-containing compound.

The oxalatoborate-based compound according to an exemplary embodiment of the disclosed technology may be a compound represented by the following Chemical Formula A or lithium bis(oxalato)borate (LiBOB (LiB(C₂O₄)₂)):

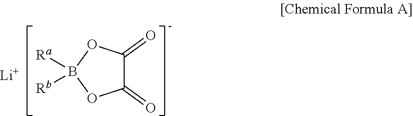

in Chemical Formula A, R^{a} and R^{b} are each independently halogen or halo C1-C10 alkyl.

Specific examples of the oxalatoborate-based compound may include lithium difluoro(oxalato)borate (LiDFOB, (LiB(C₂O₄)F₂)) and lithium bis(oxalato)borate (LiBOB, (LiB (C₂O₄)₂)).

The oxalatophosphate-based compound may be a compound represented by the following Chemical Formula B or lithium difluoro bis(oxalato)phosphate (LiDFBOP, (LiPF₂(C₂O₄)₂)).

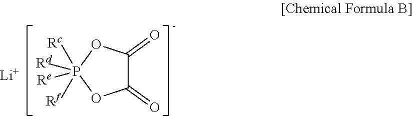

in Chemical Formula B, R^{c} to R^{f} are each independently halogen or halo C1-C10 alkyl.

Specific examples of the oxalatophosphate-based compound may include lithium tetrafluoro(oxalato)phosphate (LiTFOP, (LiPF₄(C₂O₄))) and lithium difluoro bis(oxalato)phosphate (LiDFBOP, (LiPF₂(C₂O₄)₂)).

The fluorine-substituted carbonate-based compound may be fluoroethylene carbonate (FEC), difluoroethylene carbonate (DFEC), fluorodim ethyl carbonate (FDMC), fluoroethylmethyl carbonate (FEMC), or a mixture thereof.

The vinylidene carbonate-based compound may be vinylene carbonate (VC), vinyl ethylene carbonate (VEC), or a mixture thereof.

The sulfinyl group (S═O)-containing compound may be a sulfone compound, a sulfite compound, a sulfonate compound, a sultone compound, or a sulfate compound, and these sulfinyl group-containing compounds may be used alone or in combination.

Specifically, the sulfone compound may be a sulfone compound represented by the following Chemical Formula C:

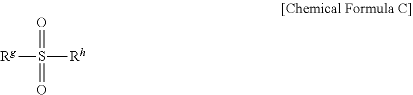

in Chemical Formula C,

R^{g} and R^{h} are each independently hydrogen, halogen, C1-C10 alkyl, C2-C10 alkenyl, halo C1-C10 alkyl, halo C2-C10 alkenyl, or C6-C12 aryl.

Non-limiting examples of the sulfone compound may include, but are not limited to, dimethyl sulfone, diethyl sulfone, ethyl methyl sulfone, methyl vinyl sulfone, and divinyl sulfone. In addition, these compounds may be used alone or as a mixture of two or more thereof.

Specifically, the sulfite compound may be a sulfite compound represented by the following Chemical Formula D:

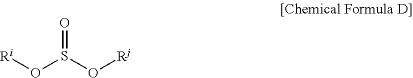

in Chemical Formula D,

Rⁱ and R^{j} are each independently hydrogen, halogen, C1-C10 alkyl, C2-C10 alkenyl, halo C1-C10 alkyl, halo C2-C10 alkenyl, or C6-C12 aryl, or Rⁱ and R^{j} may be linked to each other by —CR¹⁰⁰R¹⁰¹CR¹⁰²R¹⁰³(CR¹⁰⁴R¹⁰⁵)ₘ— to form a ring;

R¹⁰⁰ to R¹⁰⁵ are each independently hydrogen, C1-C10 alkyl, or phenyl; and

m is an integer of 0 or 1.

Non-limiting examples of the sulfite compound may include, but are not limited to, ethylene sulfite, methyl ethylene sulfite, ethyl ethylene sulfite, 4,5-dimethyl ethylene sulfite, 4,5-diethyl ethylene sulfite, propylene sulfite, 4,5-dimethyl propylene sulfite, 4,5-diethyl propylene sulfite, 4,6-dimethyl propylene sulfite, 4,6-diethyl propylene sulfite, and 1,3-butylene glycol sulfite. In addition, these compounds may be used alone or as a mixture of two or more thereof

Specifically, the sulfonate compound may be a sulfonate compound represented by the following Chemical Formula E:

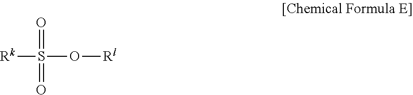

in Chemical Formula E,

R^{k} and R^{l} are each independently hydrogen, halogen, C1-C10 alkyl, C2-C10 alkenyl, haloC1-C10 alkyl, halo C2-C10 alkenyl, or C6-C12 aryl.

Non-limiting examples of the sulfonate compound may include, but are not limited to, methyl methanesulfonate, ethyl methanesulfonate, methyl ethanesulfonate, propyl methanesulfonate, methyl propanesulfonate, ethyl propanesulfonate, vinyl methanesulfonate, allyl methanesulfonate, vinyl benzenesulfonate, and allyl prop-2-ene sulfonate. In addition, these compounds may be used alone or as a mixture of two or more thereof

Specifically, the sultone compound may be a sultone compound represented by the following Chemical Formula F:

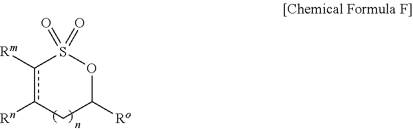

in Chemical Formula F,

[symbol] represents a single bond or a double bond;

R^{m} to R^{o} are each independently hydrogen, halogen, C1-C10 alkyl, C2-C10 alkenyl, halo C1-C10 alkyl, halo C2-C10 alkenyl, or C6-C12 aryl; and

n is an integer of 0 to 3.

Non-limiting examples of the sultone compound may include, but are not limited to, ethane sultone, 1,3-propane sultone (PS), 1,4-butane sultone (BS), ethene sultone, 1,3-propene sultone (PES), 3-fluoro-1,3-propane sultone (FPS), and 1,4-butene sultone. In addition, these compounds may be used alone or as a mixture of two or more thereof.

Specifically, the sulfate compound may be a cyclic sulfate compound represented by the following Chemical Formula G:

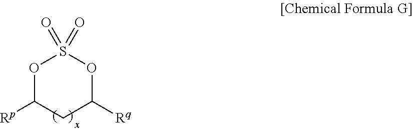

in Chemical Formula G,

R^{p} and R^{q} are each independently hydrogen, halogen, C1-C10 alkyl, C2-C10 alkenyl, halo C1-C10 alkyl, halo C2-C10 alkenyl, or C6-C12 aryl; and

xis an integer of 0 to 3.

Non-limiting examples of the sulfate compound may include, but are not limited to, ethylene sulfate (ESA), propylene sulfate, 2,3-butylene sulfate, 1,3-propylene sulfate, and 1,3-butylene sulfate. In addition, these compounds may be used alone or as a mixture of two or more thereof.

In an exemplary embodiment of the disclosed technology, the secondary battery electrolyte of the disclosed technology may further include two or more additives selected from an oxalatoborate-based compound, an oxalatophosphate-based compound, a sultone-based compound, and a sulfate-based compound.

Specifically, the secondary battery electrolyte according to an exemplary embodiment of the disclosed technology may further include two or more additives selected from fluoroethylene carbonate, difluoroethylene carbonate, fluorodimethyl carbonate, fluoroethylmethyl carbonate, lithium difluoro(oxalato)borate (LiDFOB), lithium bis(oxalato)borate (LiBOB), lithium difluoro bis(oxalato)phosphate (LiDFBOP), ethane sultone, 1,3-propane sultone, 1,4-butane sultone, ethene sultone, 1,3-propene sultone, 3-fluoro-1,3-propane sultone, 1,4-butene sultone, ethylene sulfate, propylene sulfate, 2,3-butylene sulfate, 1,3-propylene sulfate, and 1,3-butylene sulfate.

The secondary battery electrolyte according to another exemplary embodiment of the disclosed technology may further include two or more additives selected from fluoroethylene carbonate, difluoroethylene carbonate, fluorodimethyl carbonate, fluoroethylmethyl carbonate, lithium difluoro(oxalato)borate (LiDFOB), lithium bis(oxalato)borate (LiBOB), lithium difluoro bis(oxalato)phosphate (LiDFBOP), ethane sultone, 1,3-propane sultone, 1,4-butane sultone, ethene sultone, 1,3-propene sultone, 3-fluoro-1,3-propane sultone, and 1,4-butene sultone.

In an exemplary embodiment of the disclosed technology, a content of the additive is not particularly limited, but may be included in the secondary battery electrolyte in an amount of 0.2 to 10.0 wt %, and more specifically, 0.5 to 5.0 wt %, with respect to the total weight of the secondary battery electrolyte, in order to improve charge and discharge characteristics, lifespan characteristics, and storage stability.

Any lithium salt used in a secondary battery electrolyte may be used, and the lithium salt according to an exemplary embodiment of the disclosed technology may be one or two or more selected from LiPF₆, LiBF₄, LiClO₄, LiSbF₆, LiAsF₆, LiN(SO₃C₂F₅)₂, LiCF₃SO₃, LiC₄F₉SO₃, LiC₆H₅SO₃, LiSCN, LiAlO₂, LiAlCl₄, LiCl, LiI, or LiB(C₂O₄)₂, and preferably, may be one or two or more selected from LiPF₆, LiBF₄, LiClO₄, LiSbF₆, or LiAsF₆.

In the secondary battery electrolyte according to an exemplary embodiment of the disclosed technology, the lithium salt may be present at a concentration of 0.3 to 1.2 M, and preferably 0.3 to 1.0 M.

In the secondary battery electrolyte according to an exemplary embodiment of the disclosed technology, the non-aqueous organic solvent may include carbonate, ester, ether, or ketone alone, or a mixed solvent thereof, but may be selected from a cyclic carbonate-based solvent, a linear carbonate-based solvent, and a mixed solvent thereof, and a mixture of a cyclic carbonate-based solvent and a linear carbonate-based solvent may be used. The cyclic carbonate-based solvent has a large polarity and can thus sufficiently dissociate lithium ions, but has low ionic conductivity due to its high viscosity. Therefore, characteristics of a lithium secondary battery may be optimized by mixing the cyclic carbonate-based solvent with a linear carbonate-based solvent that has a small polarity but has a low viscosity.

The cyclic carbonate may be ethylene carbonate, propylene carbonate, butylene carbonate, vinylene carbonate, vinyl ethylene carbonate, fluoroethylene carbonate, or a mixture thereof, and the linear carbonate may be dimethyl carbonate, diethyl carbonate, dipropyl carbonate, ethyl methyl carbonate, methyl propyl carbonate, methyl isopropyl carbonate, ethyl propyl carbonate, or a mixture thereof.

In the secondary battery electrolyte according to an exemplary embodiment of the disclosed technology, the non-aqueous organic solvent is a mixed solvent of a cyclic carbonate-based solvent and a linear carbonate-based solvent, a mixing volume ratio of the linear carbonate-based solvent to the cyclic carbonate-based solvent may be 1 to 9:1, and preferably, the linear carbonate-based solvent and the cyclic carbonate-based solvent may be mixed at a volume ratio of 1.5 to 4:1.

The secondary battery electrolyte according to an exemplary embodiment of the disclosed technology is generally stable in a temperature range of −20° C. to 60° C., and preferably at 10° C. to 60° C., and electrochemical stability thereof is maintained even at a high voltage of 4.20 V or higher, specifically, 4.30 V or higher, and more specifically, 4.35 V or higher, based on a cathode potential. Therefore, the secondary battery electrolyte may be applied to all the lithium secondary batteries such as a lithium ion battery and a lithium polymer battery.

Non-limiting examples of the secondary battery according to an exemplary embodiment of the disclosed technology include a lithium metal secondary battery, a lithium ion secondary battery, a lithium polymer secondary battery, and a lithium ion polymer secondary battery.

In addition, the disclosed technology provides a lithium secondary battery including the secondary battery electrolyte of the disclosed technology. The lithium secondary battery of the disclosed technology includes:

a cathode;

an anode;

a separator interposed between the cathode and the anode; and

the secondary battery electrolyte according to an exemplary embodiment of the disclosed technology.

The lithium secondary battery of the disclosed technology includes the secondary battery electrolyte including the cyclophosphate compound represented by Chemical Formula 1, which is a specific compound, such that the lithium secondary battery has improved charge and discharge efficiency, high-temperature characteristics, and high-temperature storage stability, and excellent flame retardancy.

Specifically, the lithium secondary battery according to an exemplary embodiment of the disclosed technology may include:

a cathode including a nickel-cobalt-manganese-based cathode active material including a material represented by the following Chemical Formula 11, a material represented by the following Chemical Formula 12, or a mixture thereof;

an anode;

a separator interposed between the cathode and the anode; and

the secondary battery electrolyte according to an exemplary embodiment of the disclosed technology:

Liₓ(NiₐCo_{b}Mn_{c})O₂ [Chemical Formula 11]

in Chemical Formula 11, 0.5<x<1.3, 0.8≤a<1.2, 0<b<1, 0<c<1, and a+b+c=1,

Liₓ(NiₐCo_{b}Mn_{c})O₄ [Chemical Formula 12]

in Chemical Formula 12, 0.5<x<1.3, 0.8≤a<2, 0<b<2, 0<c<2, and a+b+c =2.

The lithium secondary battery according to an exemplary embodiment of the disclosed technology includes the cathode produced using an active material having a high content of nickel, and the secondary battery electrolyte including the cyclophosphate compound, which is a specific compound, such that the lithium secondary battery may be quickly charged and may have excellent low-temperature characteristics and lifespan characteristics.

As an example, a battery having a significantly high energy density is required for an electric vehicle. Therefore, the lithium secondary battery includes the cathode active material that has a high content of nickel and is usually used as a cathode material when a battery having a high energy density is operated, and also includes the secondary battery electrolyte including the cyclophosphate compound that has excellent flame retardancy, such that the lithium secondary battery has improved battery characteristics.

Specifically, the lithium secondary battery of the disclosed technology includes a combination of the secondary battery electrolyte including the cyclophosphate compound represented by Chemical Formula 1 and the specific nickel-cobalt-manganese-based cathode active material represented by Chemical Formula 11 or 12, such that the lithium secondary battery has improved charge and discharge efficiency, high-temperature stability, and lifespan characteristics and excellent flame retardancy even at a high voltage.

Furthermore, the lithium secondary battery of the disclosed technology including a combination of a specific cathode and a secondary battery electrolyte including a specific additive may have flame retardancy even at a low temperature and a high voltage, and may have improved cycle characteristics, high-temperature retention rate, storage stability, and lifespan characteristics.

The cathode active material preferably combined with the secondary battery electrolyte according to an exemplary embodiment of the disclosed technology may be represented by Chemical Formula 11, and preferably, in Chemical Formula 11, 0.8≤x<1.0, 0.8≤a<1.0, 0<b<1, 0<c<1, and a+b+c=1. Specifically, the cathode active material of the disclosed technology may be LiNi_{0.8}Co_{0.1}Mn_{0.01}O₂, LiNi_{0.88}Co_{0.06}Mn_{0.06}O₂, LiNi_{0.90}Co_{0.05}Mn_{0.05}O₂, or a mixture thereof, more preferably, LiNi_{0.88}Co_{0.06}Mn_{0.06}O₂, LiNi_{0.90}Co_{0.05}Mn_{0.05}O₂, or a mixture thereof, and still more preferably, LiNi_{0.88}Co_{0.06}Mn_{0.06}O₂.

The anode of the lithium secondary battery according to an exemplary embodiment of the disclosed technology includes an anode current collector and an anode active material layer formed on the anode current collector. The anode active material layer includes an anode active material capable of intercalating and deintercalating lithium ions. As the anode active material, a carbon material such as crystalline carbon, amorphous carbon, a carbon complex, or a carbon fiber, a lithium metal, or an alloy of lithium with another element may be used. Non-limiting examples of the amorphous carbon include soft carbon (carbon baked at a low temperature), hard carbon, coke, mesocarbon microbead (MCMB) baked at 1,500° C. or lower, and mesophase pitch-based carbon fiber (MPCF). Non-limiting examples of the crystalline carbon include a graphite-based material, specifically, natural graphite, graphitized coke, graphitized MCMB, and graphitized MPCF. The carbon material is preferably a material of which an interplanar distance is 3.35 to 3.38 Å and a crystallite size (Lc) measured by X-ray diffraction is at least 20 nm or more. As another element forming an alloy with lithium, aluminum, zinc, bismuth, cadmium, antimony, silicon, lead, tin, gallium, or indium may be used.

The cathode or the anode may be produced by dispersing an active material of each electrode, a binder, and a conductive material, and if necessary, a thickener, in a solvent to prepare an electrode slurry composition, and applying the electrode slurry composition onto an electrode current collector. As a cathode current collector, aluminum, an aluminum alloy, or the like may be mainly used, and as an anode current collector, copper, a copper alloy, or the like may be mainly used. An example of a shape of each of the cathode current collector and the anode current collector may include a foil or mesh shape.

The binder is a material playing a role in paste formation of the active material, adhesion between the active materials, adhesion with the current collector, a buffering effect on expansion and contraction of the active material, and the like. Examples of the binder include polyvinylidene fluoride (PVdF), a polyhexafluoropropylene-polyvinylidene fluoride (PVdF/HFP) copolymer, poly(vinylacetate), polyvinyl alcohol, polyethylene oxide, polyvinylpyrrolidone, alkylated polyethylene oxide, polyvinyl ether, poly(methylmethacrylate), poly(ethylacrylate), polytetrafluoroethylene, polyvinylchloride, polyacrylonitrile, polyvinylpyridine, styrene-butadiene rubber, or acrylonitrile-butadiene rubber. A content of the binder is 0.1 to 30 wt % and preferably 1 to 10 wt % with respect to the electrode active material. When the content of the binder is too small, an adhesive force between the electrode active material and the current collector is insufficient, and when the content of the binder is too large, the adhesive force is improved, but a content of the electrode active material is decreased in accordance with the content of the binder, which is disadvantageous in obtaining a battery having a high capacity.

An electrically conductive material can be used to impart conductivity to the electrode, and an electrically conductive material that does not cause a chemical change in a battery to be configured may be used. Some examples of such an electrically conductive material include a graphite-based conductive material, a carbon black-based conductive material, and a metal or metal compound-based conductive material may be used. Examples of the graphite-based conductive material include artificial graphite or natural graphite. Examples of the carbon black-based conductive material include acetylene black, ketj en black, denka black, thermal black, and channel black. Examples of the metal or metal compound-based conductive material include tin, tin oxide, tin phosphate (SnPO₄), titanium oxide, potassium titanate, and a perovskite material such as LaSrCoO₃ or LaSrMnO₃. However, the conductive material is not limited thereto.

A content of the conductive material is preferably 0.1 to 10 wt % with respect to the electrode active material. When the content of the conductive material is less than 0.1 wt %, electrochemical properties are deteriorated, and when the content of the conductive material exceeds 10 wt %, an energy density per weight is decreased.

Any thickener may be used without limitation as long as it may serve to adjust a viscosity of the active material slurry, and for example, carboxymethyl cellulose, hydroxymethyl cellulose, hydroxyethyl cellulose, hydroxypropyl cellulose, or the like may be used.

As the solvent in which the electrode active material, the binder, the conductive material, and the like are dispersed, a non-aqueous solvent or an aqueous solvent is used. Examples of the non-aqueous solvent may include N-methyl-2-pyrrolidone (NMP), dimethylformamide, dimethylacetamide, N,N-dimethylaminopropylamine, ethyleneoxide, and tetrahydrofuran.

The lithium secondary battery according to an exemplary embodiment of the disclosed technology may include a separator preventing a short circuit between the cathode and the anode and providing a movement path of the lithium ions. As such a separator, a polyolefin-based polymer film formed of polypropylene, polyethylene, polyethylene/polypropylene, polyethylene/polypropylene/polyethylene, or polypropylene/polyethylene/polypropylene, or a multi-layer thereof, a micro-porous film, a woven fabric, or a non-woven fabric may be used. In addition, a film obtained by coating a resin having excellent stability on a porous polyolefin film may be used.

The lithium secondary battery of the disclosed technology may be formed into various shapes such as a cylindrical shape and a pouch shape, in addition to an angular shape. The secondary battery is suitable for use requiring a high voltage, a high output, and driving at a high temperature, such as an electric vehicle, in addition to the existing use for a mobile phone, a portable computer, or the like. In addition, the secondary battery may also be used for a hybrid vehicle in connection with the existing internal combustion engine, fuel cell, super capacitor, or the like, and may be used for all other uses such as an electric bike and a power tool requiring a high output, a high voltage, and driving at a high temperature.

Hereinafter, examples and comparative examples of the disclosed technology will be described. However, each of the following examples is merely a preferred example of the disclosed technology, and the disclosed technology is not limited to the following examples. It is assumed that the lithium salt is all dissociated so that the concentration of the lithium ion is 1 mole (1 M) in an electrolyte. A secondary battery electrolyte was prepared by dissolving a corresponding amount of each of a lithium salt such as LiPF₆ so that a concentration of the lithium salts in the secondary battery electrolyte was 1 mole (1 M).

### EXAMPLE 1

### Preparation of PEA540

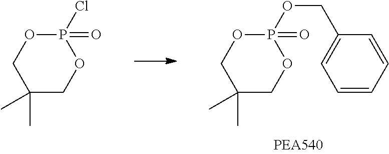

To a 500 mL round-bottom flask, a magnetic bar and NaH (2.42 g, 60.7 mmol) were added, THF (135 mL) was added under N₂ at 0° C., and the mixture was stirred for 10 minutes. The mixture was stirred while benzyl alcohol (5.37 mL, 52.0 mmol) was added dropwise thereto for 15 minutes. The mixture was additionally stirred for 30 minutes, when hydrogen was no longer generated, a solution obtained by dissolving 2-chloro-5,5-dimethyl-1,3,2-dioxaphosphorinane 2-oxide (8.0 g, 43.3 mmol) in THF (15 mL) was added dropwise, the temperature was slowly raised to room temperature, and then the mixture was stirred for 24 hours. After the reaction was completed, an NH₄Cl solution was added and the reaction solution was quenched at 0° C., and the reaction solution was extracted with ethyl acetate 3 times. Moisture was removed from the separated organic layer with MgSO₄, the solvent in the filtrate obtained by filtering the reaction solution was completely removed under reduced pressure, and then the filtrate was purified by silica gel chromatography (eluent: 25% ethyl acetate in hexane), thereby obtaining 4.8 g (18.6 mmol) of the title compound PEA540 in a yield of 43%.

¹H NMR (500 MHz, DMSO-d6) δ 7.36-7.44 (m, 5H), 5.04 (d, J=8.1 Hz, 2H), 3.95-4.05 (m, 2H), 3.88-3.93 (m, 2H), 1.14 (s, 3H), 0.80 (s, 3H) ppm

### EXAMPLE 2

### Preparation of PEA541

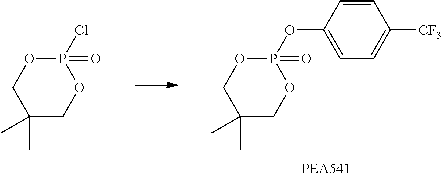

To a 2 L round-bottom flask, a magnetic bar, 4-(trifluoromethyl)phenol (75 g, 462 mmol), and toluene (850 mL) were added, and the mixture was stirred at 0° C. for 10 minutes. NaOH (18.5 g, 462 mmol) was slowly added thereto, and the mixture was stirred at 0° C. for about 1 hour. 2-Chloro-5,5-dimethyl-1,3,2-dioxaphosphorinane 2-oxide (85.4 g, 462 mmol) was slowly added thereto at 0° C., and the mixture was stirred for 24 hours while naturally raising the temperature from 0° C. to room temperature. After the reaction was completed, water and ethyl acetate were added, and the reaction solution was washed with water 2 times. MgSO₄ was added to remove moisture from the extracted organic layer, and then the solvent was completely removed under reduced pressure. A small amount of ethyl acetate was added to the obtained residue, a magnetic bar was added, the mixture was stirred, and a large amount of hexane was poured, thereby obtaining white solid crystals. The white solid crystals were washed with hexane several times, and filtering was performed, thereby obtaining 57 g (185 mmol) of the title compound PEA541 in a yield of 40%.

¹H NMR (500 MHz, CDCl3) δ 7.64 (d, J=8.8 Hz, 2H), 7.38 (d, J=8.7 Hz, 2H), 4.07-4.27 (m, 2H), 4.00-4.07 (m, 2H), 1.36 (s, 3H), 0.94 (s, 3H) ppm

### COMPARATIVE EXAMPLE 1

### Preparation of PEA289

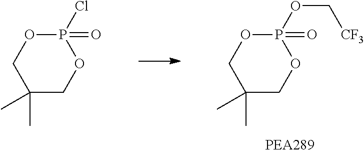

To a 1 L round-bottom flask, a magnetic bar, 2,2,2-trifluoroethanol (14.2 mL, 195.1 mmol), triethylamine (54.3 mL, 390.0 mmol), 4-(dimethylamino)pyridine (2.97 g, 24.3 mmol),and THF (200 mL) were added, and the mixture was stirred under N₂ at 0° C. A solution obtained by dissolving 2-chloro-5,5-dimethyl-1,3,2-dioxaphosphorinane 2-oxide (30 g, 162.5 mmol) in THF (250 mL) was slowly added dropwise to the reaction solution for 1 hour. The mixture was stirred for 3 hours, solids were removed through filtration, and then the solvent was completely removed from the filtrate under reduced pressure. The obtained residue was purified by silica gel chromatography (eluent: 20% ethyl acetate in hexane) to obtain 29 g (123.5 mmol) of the title compound in a yield of 76%.

¹H NMR (500 MHz, CDCl3) δ 4.36-4.42 (m, 2H), 4.13-4.16 (m, 2H), 3.92-3.99 (m, 2H), 1.29 (s, 3H), 0.89 (s, 3H) ppm

### COMPARATIVE EXAMPLE 2

### Preparation of PEA288

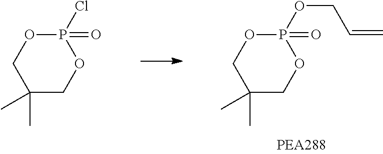

Tetrahydrofuran (THF, 10 mL) was added to sodium hydride (NaH, 0.39 g, 16.3 mmol), and stirring was performed while allyl alcohol (1.11 mL, 0.94 g, 16.3 mmol) was added dropwise for 15 minutes. The mixture was further stirred for 15 minutes, a solution obtained by dissolving 2-chloro-5,5-dimethyl-1,3,2-dioxaphosphorinane 2-oxide in tetrahydrofuran (15 mL) was added dropwise, and the mixture was stirred at room temperature for 12 hours. After the stirring was completed, the solvent was removed under reduced pressure, and the reaction solution was extracted using dichloromethane (CH₂Cl₂) (30 mL) and distilled water (30 mL), and an organic layer was separated. Residual moisture in the organic material was removed from the separated organic layer with anhydrous magnesium sulfate (MgSO4), and the reaction solution was filtered. The filtrate was concentrated under reduced pressure. The obtained residue was purified by silica gel column chromatography (eluent: 25% EtOAc in hexane), thereby obtaining 1.33 g (6.5 mmol) of the title compound in a yield of 39.7%.

¹H NMR (500 MHz, CDCl3) δ 5.86-6.04 (m, 1H), 5.22-5.40 (m, 1H), 4.51-4.61 (m, 2H), 4.08 (dd, J1=5.9 Hz, J2=8.8 Hz, 2H), 3.91 (dd, J1=8.8 Hz, J2=17.8 Hz, 2H), 1.24 (s, 3H), 0.90 (s, 3H) ppm

### EXAMPLES 3 AND 4

A solution obtained by dissolving LiPF6 in a mixed solvent obtained by mixing ethylene carbonate (EC) and ethyl methyl carbonate (EMC) at a volume ratio of 25:75 to obtain a 1.0 M solution was used as a basic electrolyte (1.0 M LiPF₆, EC/EMC=25/75), and the components shown in Table 1 were additionally added, thereby preparing an electrolyte.

A battery to which the non-aqueous electrolyte was applied was produced as follows.

LiNi_{0.88}Co_{0.06}Mn_{0.06}O₂ as a cathode active material, polyvinylidene fluoride (PVdF) as a binder, and carbon as a conductive material were mixed at a weight ratio of 98:1:1, and then the mixture was dispersed in N-methyl-2-pyrrolidone, thereby preparing a cathode slurry. The slurry was coated on an aluminum foil having a thickness of 12 μm, and the aluminum foil coated with the slurry was dried and rolled, thereby producing a cathode. Artificial graphite and natural graphite as anode active materials, styrene-butadiene rubber as a binder, and carboxymethyl cellulose as a thickener were mixed at a weight ratio of 96:2:2, and the mixture was dispersed in water, thereby preparing an anode active material slurry. The slurry was coated on a copper foil having a thickness of 8 μm, and the copper foil coated with the slurry was dried and rolled, thereby producing an anode.

A cell was configured by stacking a film separator made of polyethylene (PE) and having a thickness of 13 μm between the electrodes thus manufactured, and using a pouch having a size of thickness 5 mm×width 50 mm×length 60 mm, and the non-aqueous electrolyte was injected thereto, thereby manufacturing a 2 Ah grade lithium secondary battery for EV.

The performance of the 2 Ah grade battery for EV produced as described above was evaluated as follows. Evaluation items are as follows.

*Evaluation Items*

1. Initial performance: A process of charging the battery to 4.2 V and 0.05 C with 0.5 C CC-CV charging mode at room temperature and discharging the battery to 2.7 V with a current of 0.5 C was repeated 100 times or more. At this time, the first capacity discharge capacity was defined as 1 C, and a capacity retention rate during the lifespan was calculated by dividing the 300^{th} discharge capacity by the first discharge capacity.

2. Thickness increase rate after 4 weeks at 60° C.: When the thickness of the battery after being charged at 4.2 V with 1 C CC-CV at room temperature for 3 hours was set as ‘A’, and the thickness of the battery after being allowed to stand under a exposed normal pressure for 4 weeks in the atmosphere at 60° C. using a closed thermostat was set as ‘B’, the thickness increase rate was calculated by the following Equation 1. A cell thickness was measured using a flat plate thickness measuring apparatus (manufactured by Misutoyo Corporation, 543-490B).

Thickness increase rate (%)=(B−A)/A×100

3. Capacity retention ratio after 4 weeks at 60° C.: A battery was allowed to stand at 60° C. for 4 weeks and then at room temperature for 30 minutes, and calculation was performed by dividing a capacity obtained from 1 C rate CC discharge (2.7 V cut-off) after IR measurement by a capacity measured before storage and the result was shown in a percentage.

Capacity retention rate of battery (%)=(final capacity/initial capacity)×100 (%)

4. Capacity recovery rate after 4 weeks at 60° C. (storage efficiency at high temperature): A battery was allowed to stand at 60° C. for 4 weeks and then discharged with a current of 1 C with CC to 2.7 V, and then a usable capacity (%) relative to an initial capacity was measured.

5. Measurement of hot box delay effect: When the lithium secondary battery was fully charged, the temperature was raised to 150° C. at a rate of increase of 5° C./min, and then the temperature was maintained at 150° C., the time it takes for the battery to explode was measured.

6. Flame retardancy evaluation (self-extinguishing time measurement SET evaluation): After lighting 1 g of the electrolyte, the time for self-extinguishing the electrolyte was measured.

### COMPARATIVE EXAMPLES 3 TO 5

The same process and evaluation were performed as those in Examples 3 and 4 except that the additives for the electrolyte shown in Table 1 were changed in Examples 3 and 4. The results thereof are shown in Table 1.

The performance of the battery produced as described above was evaluated by the above evaluation items. The results thereof are shown in Table 1.

TABLE 1

| | | Example | Example | Comparative | Comparative | Comparative |
|---|---|---|---|---|---|---|
| | | 3 | 4 | Example 3 | Example 4 | Example 5 |
| Additive | Type | PEA540 | PEA541 | — | PEA289 | PEA288 |
| | Content | 10 | 10 | — | 10 | 10 |
| | (wt %) | | | | | |
| Initial | Coulombic | 82.1 | 81.8 | 82.0 | 72 | 71 |
| performance | efficiency | | | | | |
| | (%) | | | | | |
| | Capacity | 1610 | 1686 | 1737 | 1580 | 1570 |
| | (mAh) | | | | | |
| | C_DCIR | 35.41 | 39.37 | 45.22 | 31.37 | 41.9 |
| | (mΩ) | | | | | |
| | D_DCIR | 38.48 | 40.53 | 33.94 | 49.66 | 43.0 |
| | (mΩ) | | | | | |
| | Thickness | 5.08 | 5.12 | 5.11 | 5.80 | 5.92 |
| | [mm] | | | | | |
| Storage | Capacity | 80 | 90 | 91 | 75 | 73 |
| at 60° C. | retention rate | | | | | |
| (after 4 | Capacity | 82 | 92 | 93 | 77 | 75 |
| weeks) | recovery rate | | | | | |
| | C_DCIR | 60.30 | 36.51 | 28.29 | 70.11 | 77.2 |
| | (mΩ) | | | | | |
| | D_DCIR | 41.93 | 40.68 | 33.11 | 78.22 | 81.3 |
| | (mΩ) | | | | | |
| | Thickness | 1 | 1 | 2 | 23 | 39 |
| | increase rate | | | | | |
| | (%) | | | | | |
| Evaluation | Hot box | 3.2 | 2.9 | 0 | 1.2 | 1.1 |
| of retardant | delay time | | | | | |
| characteristics | (min) | | | | | |
| flame | Self- | 43 | 41 | 60 | 51 | 55 |
| | extinguishing | | | | | |
| | time (SET) | | | | | |
| | (sec) | | | | | |

It could be appreciated from Table 1 that each of the lithium secondary batteries of Examples 3 and 4 including the secondary battery electrolyte including the cyclophosphate compound of the disclosed technology had improved or equivalent charge and discharge efficiency, high-temperature storage stability, and lifespan characteristics while having excellent flame retardancy in comparison to the lithium secondary battery of Comparative Example 3 including no cyclophosphate compound and the lithium secondary batteries of Comparative Examples 4 and 5 including a cyclophosphate compound having a functional group different from that of the disclosed technology.

As set forth above, the secondary battery electrolyte according to an exemplary embodiment of the disclosed technology includes a cyclophosphate compound, such that the secondary battery electrolyte has significantly improved flame retardancy.

Further, although the secondary battery electrolyte according to an exemplary embodiment of the disclosed technology includes a cyclophosphate compound having flame retardancy, charge and discharge efficiency is not reduced even at a high voltage, and lifespan characteristics, high-temperature stability, a high-temperature capacity retention rate, and a recovery rate are significantly excellent.

Further, the secondary battery electrolyte according to an exemplary embodiment of the disclosed technology has excellent initial performance.

Therefore, a lithium secondary battery including the secondary battery electrolyte according to an exemplary embodiment of the disclosed technology has excellent flame retardancy while maintaining charge and discharge efficiency at a high voltage.

Further, the lithium secondary battery according to an exemplary embodiment of the disclosed technology includes the secondary battery electrolyte according to an exemplary embodiment of the disclosed technology, such that the lithium secondary battery has excellent high-temperature storage stability and self-extinguishing properties.

Certain examples of implementations of the disclosed technology are described. Variations or enhancements of the disclosed implementations and other implementations may be made based on what is disclosed in this patent document.

What is claimed is:

1. A secondary battery electrolyte comprising:
a lithium salt;
a non-aqueous organic solvent; and
a cyclophosphate compound represented by the following Chemical Formula 1: 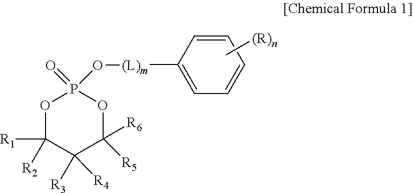
wherein, in Chemical Formula 1:
R₁ to R₆ are each independently hydrogen, C1-C10 alkyl, or C6-C12 aryl C1-C10 alkyl;
L is C1-C5 alkylene;
R is fluoro or fluoro C1-C10 alkyl;
m is an integer of 0 to 2; and
n is an integer of 0 to 5.

2. The secondary battery electrolyte of claim 1, wherein, in Chemical Formula 1: R₁ to R₆ are each independently hydrogen, C1-C5 alkyl, or C1-C5 alkyl substituted with phenyl; L is C1-C3 alkylene; R is fluoro or fluoro C1-C5 alkyl; m is an integer of 0 or 1; and n is an integer of 0 to 2.

3. The secondary battery electrolyte of claim 1, wherein the cyclophosphate compound is a cyclophosphate compound represented by the following Chemical Formula 2: 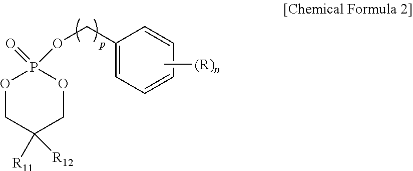
wherein, in Chemical Formula 2:
R is fluoro or fluoro C1-C10 alkyl;
R₁₁ and R₁₂ are each independently hydrogen, C1-C10 alkyl, or C6-C12 aryl C1-C10 alkyl;
p is an integer of 0 to 3; and
n is an integer of 0 to 5.

4. The secondary battery electrolyte of claim 3, wherein, in Chemical Formula 2: R is fluoro or perfluoro C1-C5 alkyl; R₁₁ and R₁₂ are each independently hydrogen, C1-C5 alkyl, or phenyl C1-C5 alkyl; p is an integer of 0 to 2; and n is an integer of 0 to 3.

5. The secondary battery electrolyte of claim 1, wherein the cyclophosphate compound is selected from the following compounds:

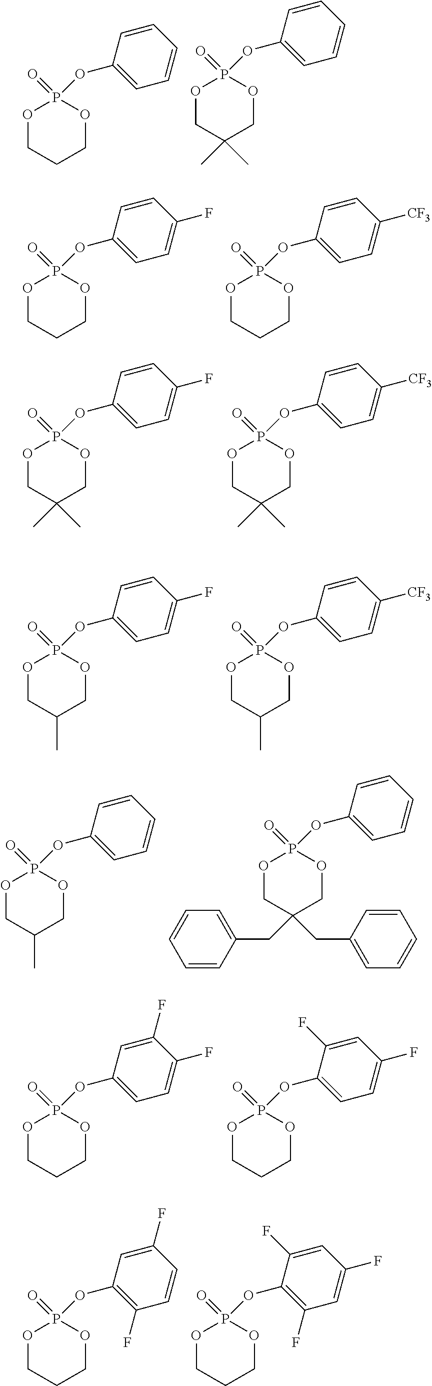

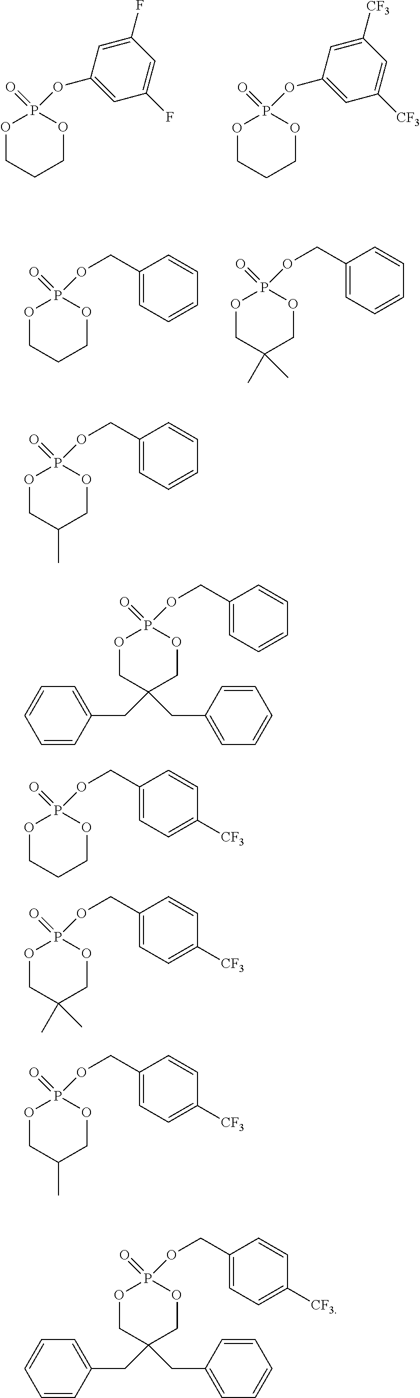

6. The secondary battery electrolyte of claim 1, wherein the cyclophosphate compound is in an amount of 1 to 15 wt % with respect to a total weight of the secondary battery electrolyte.

7. The secondary battery electrolyte of claim 1, further comprising one or more additives selected from an oxalatoborate-based compound, an oxalatophosphate-based compound, a fluorine-substituted carbonate-based compound, a vinylidene carbonate-based compound, or a sulfinyl group-containing compound.

8. The secondary battery electrolyte of claim 7, wherein the additive is in an amount of 0.2 to 5 wt % with respect to a total weight of the secondary battery electrolyte.

9. The secondary battery electrolyte of claim 1, wherein the lithium salt includes one or more of LiPF₆, LiBF₄, LiClO₄, Li SbF₆, LiAsF₆, LiN(SO₃C₂F₅)₂, LiCF₃SO₃, LiC₄F₉SO₃, LiC₆H₅SO₃, LiSCN, LiAlO₂, LiAlCl₄, LiCl, LiI, or LiB(C₂O₄)₂.

10. The secondary battery electrolyte of claim 9, wherein the lithium salt is present in an amount of 0.3 to 1.2 moles.

11. A lithium secondary battery comprising:
a cathode;
an anode;
a separator interposed between the cathode and the anode; and
a secondary battery electrolyte comprising:
a lithium salt;
a non-aqueous organic solvent; and
a cyclophosphate compound represented by the following Chemical Formula 1: 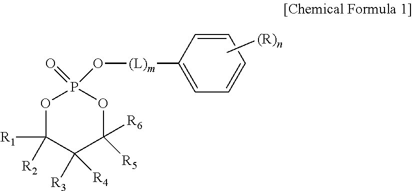
wherein, in Chemical Formula 1:
R₁ to R₆ are each independently hydrogen, C1-C10 alkyl, or C6-C12 aryl C1-C10 alkyl;
L is C1-C5 alkylene;
R is fluoro or fluoro C1-C10 alkyl;
m is an integer of 0 to 2; and
n is an integer of 0 to 5.

12. The lithium secondary battery of claim 11, wherein, in Chemical Formula 1: R₁ to R₆ are each independently hydrogen, C1-C5 alkyl, or C1-C5 alkyl substituted with phenyl; L is C1-C3 alkylene; R is fluoro or fluoro C1-C5 alkyl; m is an integer of 0 or 1; and n is an integer of 0 to 2.

13. The lithium secondary battery of claim 11, wherein the cyclophosphate compound is a cyclophosphate compound represented by the following Chemical Formula 2: 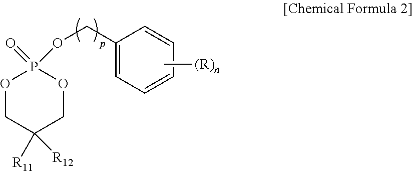
wherein, in Chemical Formula 2:
R is fluoro or fluoro C1-C10 alkyl;
R¹¹ and R₁₂ are each independently hydrogen, C1-C10 alkyl, or C6-C12 aryl C1-C10 alkyl;
p is an integer of 0 to 3; and
n is an integer of 0 to 5.

14. The lithium secondary battery of claim 13, wherein, in Chemical Formula 2: R is fluoro or perfluoro C1-C5 alkyl; R₁₁ and R₁₂ are each independently hydrogen, C1-C5 alkyl, or phenyl C1-C5 alkyl; p is an integer of 0 to 2; and n is an integer of 0 to 3.

15. The lithium secondary battery of claim 11, wherein the cyclophosphate compound is selected from the following compounds:

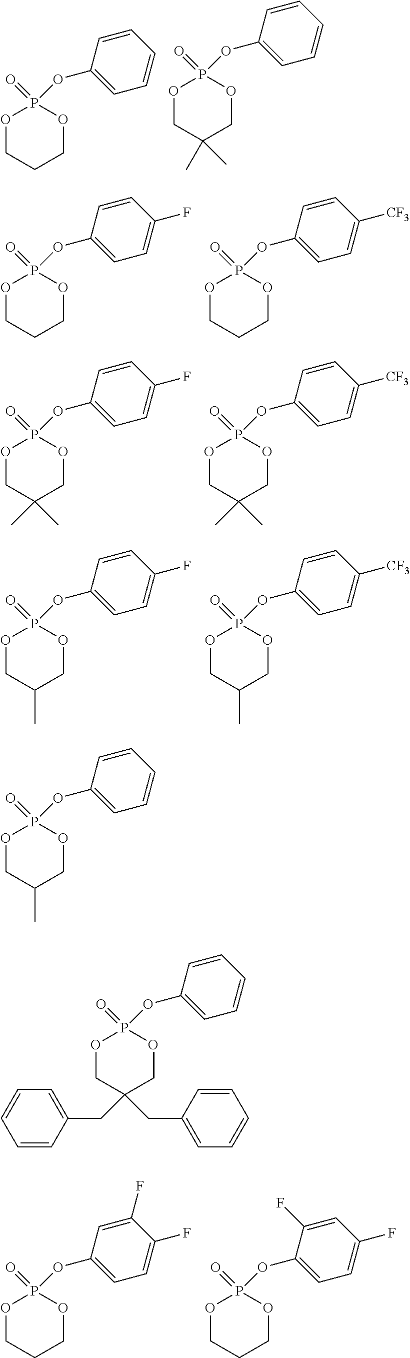

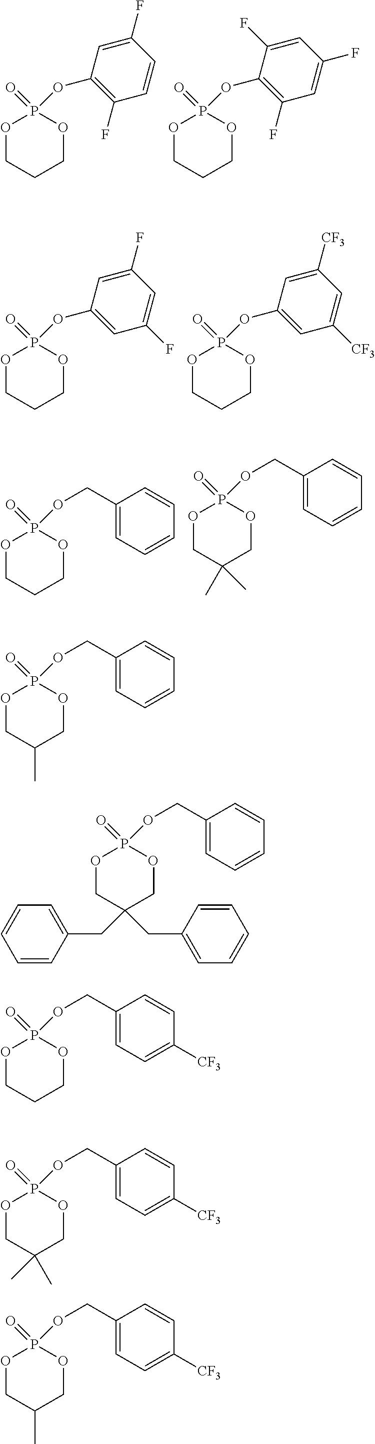

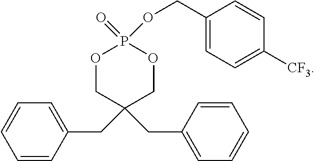 [SMILES: O=P1(OCc2ccc(C(F)(F)F)cc2)OCC(Cc2ccccc2)(Cc2ccccc2)CO1]

16. The lithium secondary battery of claim 11, wherein the cyclophosphate compound is in an amount of 1 to 15 wt % with respect to a total weight of the secondary battery electrolyte.

17. The lithium secondary battery of claim 11, further comprising one or more additives selected from an oxalatoborate-based compound, an oxalatophosphate-based compound, a fluorine-substituted carbonate-based compound, a vinylidene carbonate-based compound, or a sulfinyl group-containing compound.

18. The lithium secondary battery of claim 17, wherein the additive is in an amount of 0.2 to 5 wt % with respect to a total weight of the secondary battery electrolyte.

19. The lithium secondary battery of claim 11, wherein the lithium salt is one or more of LiPF₆, LiBF₄, LiClO₄, LiSbF₆, LiAsF₆, LiN(SO₃C₂F₅)₂, LiCF₃SO₃, LiC₄F₉SO₃, LiC₆H₅SO₃, LiSCN, LiAlO₂, LiAlCl₄, LiCl, LiI, or LiB(C₂O₄)₂.

20. The lithium secondary battery of claim 19, wherein the lithium salt is present in an amount of 0.3 to 1.2 moles.
